(19) United States
(12) Patent Application Publication
(10) Pub. No.: US 2010/0302917 A1
(43) Pub. Date: Dec. 2, 2010

(54) Music Extracting Apparatus And Recording Apparatus

(75) Inventors: Satoru MATSUMOTO, Kasai-shi, Hyogo (JP); Yuji YAMAMOTO, Yawata-shi (JP); Tatsuo KOGA, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/855,995

(22) Filed: Aug. 13, 2010

Related U.S. Application Data
(63) Continuation-in-part of application No. PCT/JP2009/000556, filed on Feb. 12, 2009.

(30) Foreign Application Priority Data
Feb. 13, 2008 (JP) 2008-032067

(51) Int. Cl. H04H 60/27; G11B 5/00

(52) U.S. Cl. 369/7; G9B/5

(57) ABSTRACT

A music extracting apparatus has a receiving unit which receives a broadcast signal having a plurality of channels of audio signals, a detecting unit which detects a variation of voice power from the audio signal, a computing unit which computes a difference of amplitude or power between the audio signals of each channel, and a specifying unit which specifies the starting or the ending position of a music section based on the variation detected by the detecting unit and the difference computed by the computing unit.

### CROSS-REFERENCE TO RELATED APPLICATIONS

This application is a continuation-in part application of Patent Cooperation Treaty Patent Application No. PCT/JP2009/000556 (filed on Feb. 12, 2009), which claims priority from Japanese patent application JP 2008-032067 (filed on Feb. 13, 2008). All of which are hereby incorporated by reference herein.

### TECHNICAL FIELD

The present invention relates to a music extracting apparatus which extracts music portion from broadcasting signals such as radio broadcast or television broadcast, and a music recording apparatus which records the extracted music portion.

### BACKGROUND ART

In music program provided on radio or TV broadcasting, most of them are constituted from talk section, such as MC (Master of Ceremony) or DJ (Disc Jockey), and music section. In these programs, talk sections usually exist between music sections. Sometimes the voice of DJ overlaps in the starting or ending portion of the music sections.

In JP 2005-518560 A1, an apparatus, which extracts music portion from the broadcasting waves, is disclosed. In the apparatus, the starting and the ending position of music section is detected only by stereophonic information. Specifically, it determines that the starting position is detected when the difference value between the audio signals of left and right channels exceeds a first predetermined value, and determines that the ending position is detected when the difference value lowers the second predetermined value (1).

However, in the conventional method, it sometimes mistakenly determines that the ending position of the music section is detected when the music section has a non stereo-like portion in its midstream.

### SUMMARY

A first music extracting apparatus of the present invention comprises a receiving unit which receives a broadcast signal having a plurality of channels of audio signals; a detecting unit which detects a variation of voice power from the audio signal; a computing unit which computes a difference of amplitude or power between the audio signals of each channel, and a specifying unit which specifies the starting or the ending position of a music section based on the variation detected by the detecting unit, and the difference computed by the computing unit.

A second music extracting apparatus of the present invention comprises a receiving unit which receives a broadcast signal having a left and right channels of audio signals; a detecting unit which detects a transition point where variation of voice power of the audio signal exceeds predetermined value; a computing unit which computes an amplitude difference between the audio signals of each channel, and a specifying unit which specifies the starting or the ending position of a music section based on the amplitude difference in the vicinity of the transition point.

A music recording apparatus of the present invention comprises a receiving unit which receives a broadcast signal having a plurality of channels of audio signals; a detecting unit which detects a variation of voice power from the audio signal; a computing unit which computes a difference of amplitude or power between the audio signals of each channel; a specifying unit which specifies the starting and the ending position of a music section based on the variation detected by the detecting unit, and the difference computed by the computing unit, and a recording unit which records the music section specified by the specifying unit.

### BRIEF DESCRIPTION OF THE DRAWINGS

FIG. 1 is a block diagram showing the configuration of music recording and reproducing apparatus.

FIG. 2 is a flow chart showing a procedure of music recording process.

FIG. 3 is a flow chart showing a procedure of computation of stereo likelihood in the vicinity of the transition point.

FIG. 4 is a diagram for explaining a music recording process.

### DETAILED DESCRIPTION

The present invention embodied in a music extracting apparatus or music recording apparatus is specifically described below with the reference to the drawings.

### [1] Configuration of a Music Recording and Reproducing Apparatus

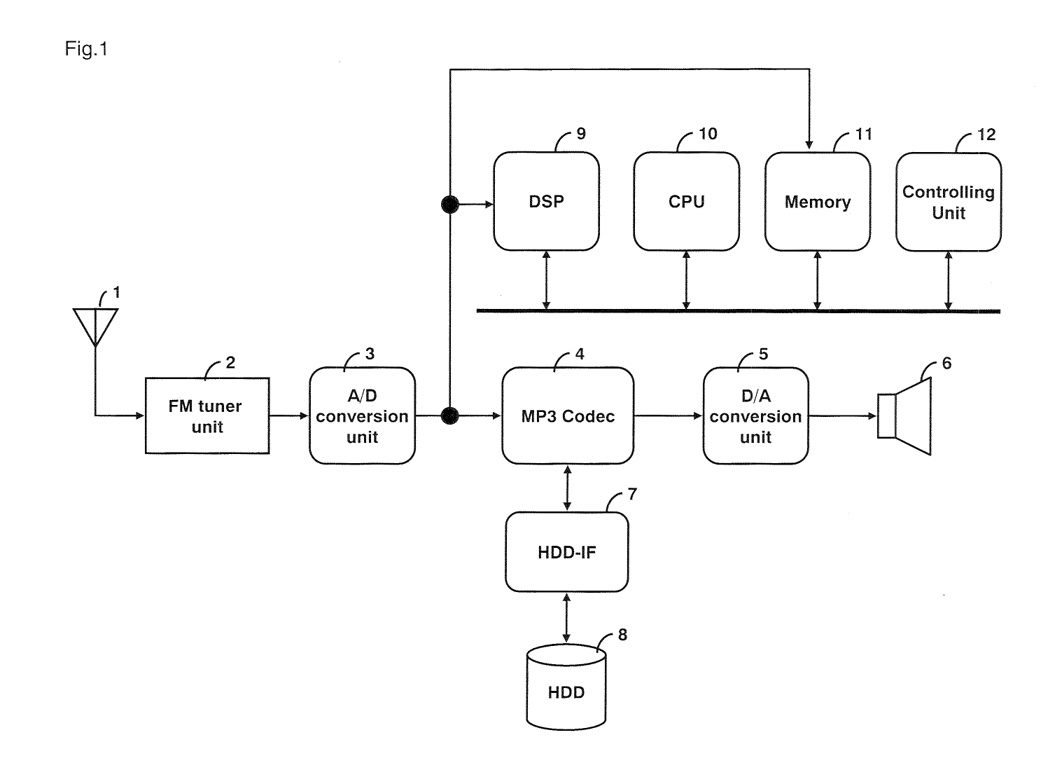

FIG. 1 shows the configuration of the music recording and reproducing apparatus. The apparatus has an antenna 1, a FM (Frequency Modulation) tuner unit 2, an A/D (Analog to Digital) conversion unit 3, MP3 codec 4, a D/A (Digital to Analog) conversion unit 5, a speaker unit 6, a HDD-IF (Hard Disk Drive-Interface) 7, a HDD (Hard Disk Drive) 8, a DSP (Digital Signal Processor) 9, a CPU (Central Processing Unit) 10, a memory 11, and a controlling unit 12.

The FM tuner unit 2 tunes in a broadcast wave chosen by user among the FM broadcast wave inputted from the antenna 1. Then, the unit 2 demodulates the tuned wave and outputs analog audio signals (i.e. the audio signal of the left channel and the right channel). The A/D conversion unit 3 converts the analog signal acquired by the unit 2 to the digital audio signal. The MP3 codec 4 encodes the digital audio signal to a data compressed by MP3 format. Further, the codec 4 decodes the MP3 compressed data readout from the HDD 8 to a digital audio signal. The HDD-IF 7 interfaces with the HDD 8. The HDD 8 is a mass storage device for example.

The DSP 9 detects a transition point from an inputted audio data. The DSP 9 also computes stereo likelihood. Here the transition point is a point where the variation of the power of the audio signal is larger than a predetermined value. The stereo likelihood is expressed by a difference value between the audio data of the left channel and the right channel. The DSP 9 computes the variation of the power of the audio data in order to detect the transition point.

CPU 10 controls each part of the music recording and reproducing apparatus. The memory 11 operates as a work memory of the CPU 10. A program for CPU 10 is stored in ROM (not illustrated). In HDD 8, a data, which is compressed and encoded in MP3 format by the MP3 codec 4, is recorded. The D/A conversion unit 5 converts a digital audio signal, which is acquired by a decoding function of the codec 4, to an analog audio signal. The speaker unit 6 outputs the analog audio signal acquired by the D/A conversion unit 5.

### [2] Musical Recording Process

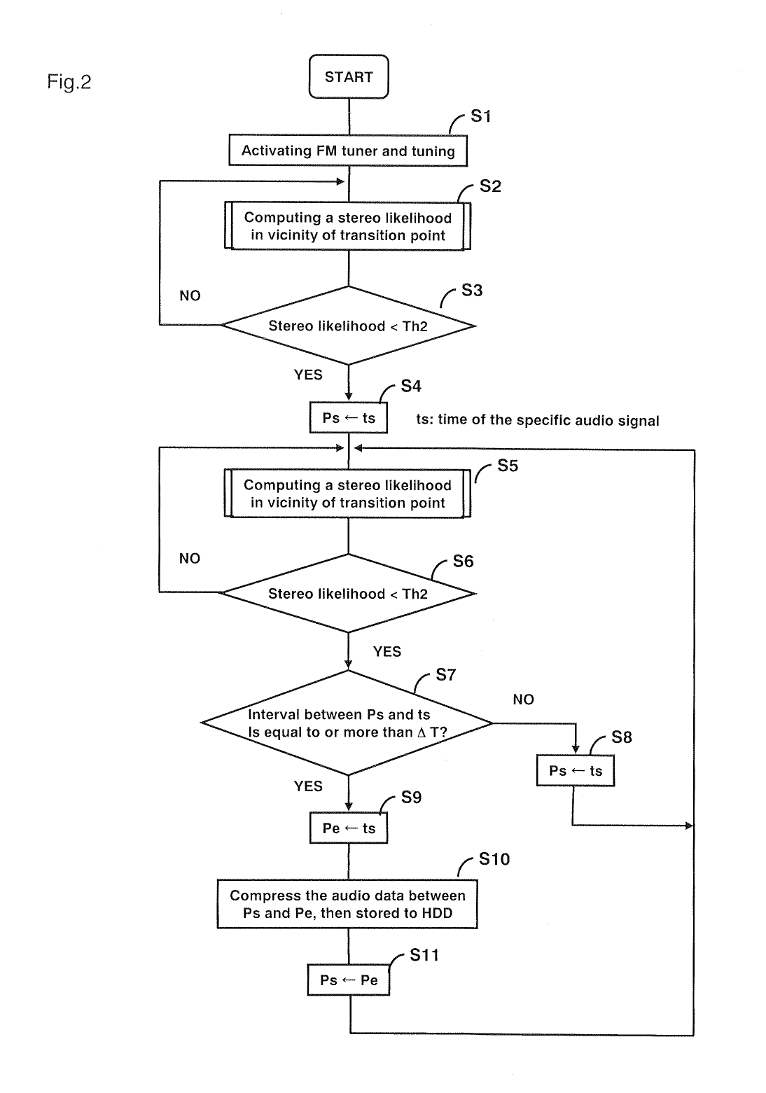

FIG. 2 shows a procedure of music recording process. When recording the music, an audio data from the A/D conversion unit 3 is input to the DSP 9 as well as to the memory 11. In a first predetermined area of the memory 11, a first predetermined amount of a new audio data is stored temporarily. This amount corresponds to an audio data for a couple songs (for example, audio data for 15 minutes long). In a second predetermined area of the memory 11, a second predetermined amount of new audio data is stored temporarily. This amount is corresponds to an audio data for a short time period (for example, 10 seconds).

Further, during the recording process, the DSP 9 keeps computing the amplitude difference value of the audio data between the left and right channels. Then the computed value is stored in the third predetermined area of the memory 11. In the third area, the amplitude difference value for the recent 10 seconds is stored, for example.

The CPU 10 starts the recording process triggered by a user's instruction. When the process has started, the CPU 10 activates the FM tuner unit 2, and controls the unit 2 so that the broadcast station selected by the user is tuned. Further, the CPU 10 controls DSP 9 so that the amplitude difference of the left and right channel is computed, and then the computed value is stored in the third area of the memory 11 (step S1). The output of FM tuner unit 2 is transmitted to the A/D conversion unit 3, and is converted to digital audio data. This audio data is then transmitted to the DSP 9 as well as to the memory 11. Thereby storing processes of the audio data to the first and the second area of the memory 11 are started.

Then, when the amount of the data stored to the first area has reached the first predetermined amount, the oldest stored data is deleted from the area while the newest data is stored in turn. Similarly, when the amount of the data stored to the second area has reached the second predetermined amount, the oldest stored data is deleted from the second area while the newest data is stored in turn.

The DSP 9 starts a computing process of the amplitude difference between the audio data of the left and the right channels inputted to the DSP 9, and store the result to the third area of the memory 11. Then, the DSP 9 and CPU 10 perform detecting process of the transition point, and the computing process of the stereo likelihood in vicinity of the transition point (step S2).

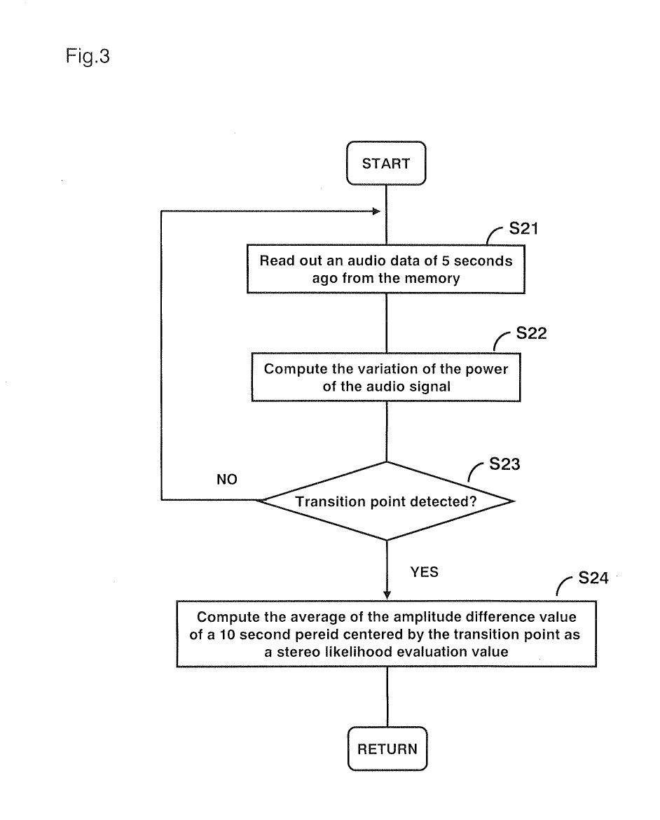

FIG. 3 shows a computing process of the stereo likelihood. First, the DSP 9 read outs a data which was received 5 seconds before the current time as a target audio data from the second area of the memory 11, wherein the second area stores an audio data which corresponds to 10 seconds long (step S21). Then, the DSP 9 computes the variation of the power of the audio signal and provides to the CPU 10 (step S22). Here, the power corresponds to a squared value of the amplitude of audio signal, for example.

The CPU 10 determines whether the target audio data regards to the transition point or not based on the variation of the power information of the audio signal inputted from the DSP 9 (step S23). When the variation is larger than a threshold value Th1, it is determined that the target audio data regards to the transition point. When determined that it does not regards to the transition point, it goes back to step S21 and process of the steps S21 to S23 are processed again.

When it is determined that the target audio data regards to the transition point in the step S23, the amplitude difference value stored in the third area of the memory 11 is read out. Specifically, the value corresponding to ten second long audio data centered by the transition point is read out. Then the average value of the ten second long data is computed as a stereo likelihood evaluation value. Thereby, computing process of the stereo likelihood is performed.

Again referring to FIG. 2, when the computing process of the step S2 is completed, then it is determined whether the stereo likelihood evaluation value computed in step S2 is lower than a threshold value Th2 or not. When it is equal to or more than Th2, it determines that the target audio data regards to the music portion and then goes back to step S2 again.

When the evaluation value is less than Th2 in the step S3, it is determined that the target audio data is a talk section such as MC or DJ. In this case, since there is a possibility that the music section may exist afterwards, the time stamp information of the target audio data is memorized as a music starting time Ps (step S4). Then, the process proceeds to step S5. In the step S5, stereo likelihood in vicinity of the transition point is computed in similar manner as step S2.

When the computation of step S5 is finished, it is determined that whether the evaluation value computed at step S5 is less than Th2 or not (step S6). When evaluation value is equal to or more than Th2, the target audio data is determined as a music section. Then, it returns to step S5.

When the evaluation value is less than Th2 in the step S6, the target audio data is determined to be a talk section such as MC or DJ, and is not a music section. Then, it is determined whether the interval between the music starting time Ps and the target audio data is equal to or more than the predetermined time ΔT (step S7). In other word, it is determined whether the interval between a transition point currently determined as a talk section and the transition point previously determined as a talk section is equal to or more than ΔT or not.

When the interval is less than ΔT, then it determines that the this section is not long enough for the music section and updates the music starting time Ps to the time of the target audio data (step S8). Then it returns to step S5. When the interval is determined to be equal to or longer than ΔT, the time of the target audio data is memorized as a music ending time Pe (step S9). Then the audio data existing between the time Ps and Pe is extracted from the audio data stored in the first area of the memory 11 as a music data. The extracted data is then compressed by the MP3 codec 4, and is recorded on HDD 8 (step S10). Then, Ps is updated to a time memorized as Pe (Step S11), and returns to step S5.

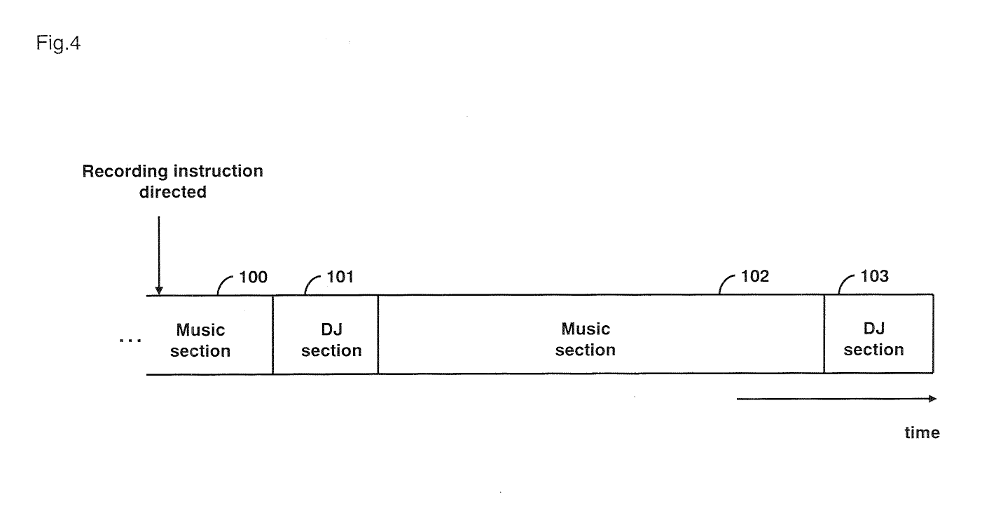

The music recording process is terminated when directed by the user's operation. Here it is presumed that a music section 100, a first DJ section 101, a music section 102, and a second DJ section 103 appears in this order, as shown in FIG. 4. And it is presumed that the recording direction is inputted in the middle of the music section 100. In such case, an audio data of the section 100 is read out from the second area of the memory 11 as a processing data and then transmitted to the DSP 9. However, during this period, it may be determined in step S2 that no transition point is detected. Even if the transition point is detected, it may be determined “no” in the step S3, since the stereo likelihood evaluation value is equal to or more than Th2. Thus, the process of step S2 is carried on or the process of steps S2 and S3 are iterated.

Next, when an audio data of the first DJ section 101 is read out from the second area of the memory 11, a transition point is detected in the step S2. Further, since the stereo likelihood evaluation value at the transition point would be less than Th2, it is determined “yes” in the step S3. Therefore, the time of this transition point is recorded as a music starting time Ps in step S4. Then, it proceeds to step S5.

When a transition point is detected in the step S5, since it is likely that the evaluation value is less than Th2, it proceeds to step S7. However, the interval between the time memorized as Ps and the target audio data is less than ΔT, thus it is determined “no” in step S7 and Ps is updated in step S8. Thereby, the processes of step S6 to S8 are iterated.

Next, when an audio data of the music section 102 is read out from the second area of the memory 11, a transition point may not be detected in the step S5. Even if the transition point is detected, since the stereo likelihood evaluation value would be equal to or more than Th2, it is determined “no” in the step S6. Thus, the process of step S5 is carried on or the process of steps S5 and S6 are iterated.

Next, when an audio data of the second DJ section 103 is read out from the second area of the memory 11, a transition point may be detected in the step S5. Further, since the stereo likelihood evaluation value at the transition point would be less than Th2, it is determined “yes” in the step S6 and proceeds to step S7. Since an interval of time memorized as Ps, and the target audio data is equal to or more than ΔT, it is determined “yes” in step S7 and proceeds to step S9. In the step S9, the time corresponding to the target audio data is memorized as Pe. Then, the audio data existing in a period between Ps and Pe is extracted as a music section data from the data memorized in the first area of the memory 11. Then the extracted data is compressed and recorded to the HDD 8.

In order to raise the detection accuracy of the starting or ending position of the music section, it is desirable to set the threshold low so that many transition points can be detected. However, if the threshold is set too low, the numbers of the transition point detected inside the music section tends to increase. In such case, it may mistakenly detect that the ending point has appeared, when there is low stereo likelihood part in the music section. Therefore, it is desirable to detect the starting and ending point of the music section further considering a frequency characteristic in vicinity of a transition point.

In other words, in the above embodiments, first, it is determined whether the audio data regards to talk section or music section based on the average value of the difference of the left and right channel signals. Then, the starting and the ending positions are specified. However, it may determine further considering frequency characteristics as well.

An example of frequency characteristics may be MFCC (Mel Frequency Cepstrum Coefficient). Specifically, the likelihood between the MFCC detected in the vicinity of the transition point and the MFCC of the prepared standard data is computed. Then it is determined that the audio data in the vicinity of the transition point is music section when the likelihood is equal to or more than Th3 and the stereo likelihood evaluation value is equal to or more than Th2.

The present invention is not limited to the foregoing embodiment but can be modified variously by one skilled in the art without departing from the spirit of the invention as set forth in the appended claims.

1. A music extracting apparatus comprising:
a receiving unit which receives a broadcast signal having a plurality of channels of audio signals;
a detecting unit which detects a variation of voice power from the audio signal;
a computing unit which computes a difference of amplitude or power between the audio signals of each channel, and
a specifying unit which specifies the starting or the ending position of a music section based on the variation detected by the detecting unit, and the difference computed by the computing unit.

2. A music extracting apparatus comprising:
a receiving unit which receives a broadcast signal having a left and right channels of audio signals;
a detecting unit which detects a transition point where variation of voice power of the audio signal exceeds predetermined value;
a computing unit which computes an amplitude difference between the audio signals of each channel, and
a specifying unit which specifies the starting or the ending position of a music section based on the amplitude difference in the vicinity of the transition point.

3. The apparatus of claim 2, wherein the specifying unit comprises:
a first means to store a time point as a starting position of the music section, wherein the time point is the transition point and where an average value of the amplitude difference between the audio signals of the left and the right channel is lower than the predetermined value;
a second means to determine whether the average value in the vicinity of the transition point subsequent to the starting position is less than a predetermined value or not;
a third means to determine whether the time between the starting position and the transition point is larger than a predetermined value or not, when the average value is detected to be lower than the predetermined value in the second means;
a fourth means to update the starting position to the transition point when the time is shorter than a predetermined value;
a fifth means to store a time point as an ending position of the music section, when time is longer than the predetermined value.

4. The apparatus of claim 3, wherein the specifying unit comprises:
a sixth means to store the ending position of the music section as a starting position of the subsequent music section, and
a seventh means to determine whether the average value in the vicinity of the transition point subsequent to the starting position is less than a predetermined value or not;

5. The apparatus of claim 2, further comprising:
a second computing unit which computes the characteristic amount on the frequency domain of the audio signal, wherein
the specifying unit specifies the starting and/or ending position of the music section based also on the characteristic amount.

6. The apparatus of claim 2, wherein
the amplitude difference in the vicinity of the transition point is an average value of the amplitude difference between the audio signal of the left and the right channels during the predetermined period centered by the transition point.

7. A music recording apparatus comprising:
a receiving unit which receives a broadcast signal having a plurality of channels of audio signals;
a detecting unit which detects a variation of voice power from the audio signal;
a computing unit which computes a difference of amplitude or power between the audio signals of each channel;
a specifying unit which specifies the starting and the ending position of a music section based on the variation detected by the detecting unit, and the difference computed by the computing unit, and
a recording unit which records the music section specified by the specifying unit.
